(19) United States
(12) Patent Application Publication
(10) Pub. No.: US 2022/0294809 A1
(43) Pub. Date: Sep. 15, 2022

(54) LARGE SCALE SURVEILLANCE OF DATA NETWORKS TO DETECT ALERT CONDITIONS

(71) Applicant: REFINITIV US ORGANIZATION LLC, New York, NY (US)

(72) Inventor: Carl A. Nabar, Stamford, CT (US)

(73) Assignee: REFINITIV US ORGANIZATION LLC, New York, NY (US)

(21) Appl. No.: 17/551,348

(22) Filed: Dec. 15, 2021

Related U.S. Application Data
(60) Provisional application No. 63/159,191, filed on Mar. 10, 2021.
(60) Provisional application No. 63/179,840, filed on Apr. 26, 2021.

(51) Int. Cl. H04L 9/40

(52) U.S. Cl. CPC H04L 63/1416; H04L 63/1433; H04L 63/1425; H04L 63/1466

(57) ABSTRACT

Systems and methods may detect alert conditions in data networks. An electronic surveillance system may learn filter parameters during a learning phase and apply the filter parameters to detect the alert conditions during a detecting phase. In the learning phase, the electronic surveillance system may learn filter parameters based on patterns in historical datasets. The electronic surveillance system may learn and evaluate the input dataset against one or more filter parameters to determine whether the input dataset should trigger an alert condition. For example, the electronic surveillance system may learn one or more filter parameters through statistical analyses, which may include machine-learning techniques. The electronic surveillance system may further match text in a dictionary filter parameter with communications, which may relate to the input datasets, to determine whether to trigger an alert condition.

### RELATED APPLICATIONS

This application claims priority to U.S. Provisional Patent Application No. 63/159,191, filed on Mar. 10, 2021, and U.S. Provisional Patent Application No. 63/178,840, filed on Apr. 23, 2021, the contents of which are incorporated by reference in their entireties herein.

### BACKGROUND

Data networks may generate data at speeds and scale that is unprecedented. A single service executing on a data network that operates around the clock may generate 22,464,000,000,000,000,000, or roughly 2.25×10¹⁹ data records in a single year. These data networks may also be continuously subjected to malicious activity on their platforms. However, it is oftentimes difficult to distinguish between malicious and non-malicious activity. Furthermore, given the amount of the generated data, automated surveillance is difficult and well beyond the scale of manual human-intervention.

### SUMMARY

Systems and methods are disclosed for detecting alert conditions in data networks. For example, an electronic surveillance system may learn filter parameters during a calibration, or learning, phase and apply the filter parameters to detect the alert conditions during a detecting phase. In the learning phase, the electronic surveillance system may learn filter parameters based on patterns in historical datasets. A filter parameter may refer to a value that indicates whether or not the input data is abnormal, or otherwise deviates from the norm. For example, a filter parameter may indicate a quantity in the input data that is higher (or lower) than the norm, a timing in the input data that is faster (or slower) than the norm, and/or other quantitative value used to determine a deviation from the norm. The filter parameter may include a ratio such as a percentage, a specific value, a range of values, and/or other quantitative value. The electronic surveillance system may learn and evaluate the input dataset against one or more filter parameters to determine whether the input dataset should trigger an alert condition. The term “learn” and similar terms used throughout may refer to computational learning of the filter parameters in which the electronic surveillance system learns the filter parameters through an analysis of the historical datasets. For example, the electronic surveillance system may learn one or more filter parameters through statistical analyses, which may include machine-learning techniques.

In some examples, the electronic surveillance system may learn filter parameters and/or detect alert conditions using a multi-tiered approach. For example, the electronic surveillance system may learn and/or apply filter parameters specific for each tier from among multiple tiers. Each tier may include its own sample size of historical datasets, which is different from the sample size of other tiers, thereby providing customizable, flexible, and comprehensive sizes of historical datasets.

In some examples, the electronic surveillance system may learn filter parameters and/or detect alert conditions using a multi-branched approach. For example, the electronic surveillance system may learn and/or apply filter parameters specific to a given branch from among multiple branches. Each branch may relate to its own source associated with the historical datasets. For example, a first historical dataset may be associated with a first source while a second historical dataset may be associated with a second source. The first source may indicate that data in the first historical dataset was the result of a transaction initiated from a Graphical User Interface (“GUI”) while the second source may indicate that data in the second historical dataset was the result of a transaction initiated from an Application Programming Interface (“API”). The first and second historical datasets may therefore exhibit different characteristics, and the electronic surveillance system may learn and/or apply filter parameters for each. Other sources may be used as well or instead of the GUI or API source.

In some examples, computational modeling may include machine-learning techniques. For example, in supervised machine-learning, labeled data in the historical datasets may be used to correlate filter parameters with the labeled data. In these supervised machine-learning examples, the filter parameters may be based on weights learned from correlating the filter parameters with the labeled data. In unsupervised machine-learning examples, values associated with the filter parameters may be clustered together to determine correlations amongst these values. Such clustering may be used for analysis to determine that input data to be assessed is similar to clustered values in the historical datasets and that the outcome for the input data will likely be the same as outcome associated with the clustered values. In reinforcement learning examples, outcomes of predictions made by the electronic surveillance system, and use those as labeled data for further training. The electronic surveillance system may adjust weights associated with the learned filter parameters based on the received outcomes.

In some examples, the electronic surveillance system may transfer learning of filter parameters between datasets based on common data between the datasets. For example, a first dataset may have sufficient quantity of data from which to learn a filter parameter while a second dataset may have insufficient quantity of data from which to learn the filter parameter. The first dataset and the second dataset may have common data that is included in both the first dataset and the second dataset. The common data may relate to the filter parameter learned from the first dataset. In this example, the electronic surveillance system may apply the filter parameter learned from the first dataset to the second dataset based on the common data even though the second dataset had insufficient quantity of data from which to learn the filter parameter.

In some examples, the electronic surveillance system may include a dictionary filter datastore that stores text that may indicate an alert condition. The electronic surveillance system may generate an alert condition if the input data matches text stored in the dictionary filter datastore. The input data in this example may include a record of communications, such as documents, chats, emails, and/or other communications. Such matches may be exact matches or inexact matches to mitigate against spelling errors. The text stored in the dictionary filter datastore may further include shorthand equivalents of words or phrases to mitigate against shorthand notation. In some examples, the electronic surveillance system may learn text to add to the dictionary filter datastore based on supervised or unsupervised machine-learning.

In the detecting phase, the electronic surveillance system may evaluate input data for which an alert condition is to be assessed against one or more filter parameters and/or the dictionary filter datastore. The filter parameters may include learned filter parameters and/or user-defined filter parameters. In some examples, the electronic surveillance system may override, or replace, a given learned filter parameter with a corresponding user-defined filter parameter. In these examples, the electronic surveillance system may apply only learned filter parameters, apply only user-defined filter parameters, or use a combination of learned and user-defined filter parameters.

The electronic surveillance system may generate an alert condition for the input data based on the application of the learned and/or user-defined filter parameters. For example, the electronic surveillance system may generate a difference between a value in the input parameter and a corresponding value in the historical datasets. The electronic surveillance system may compare the difference with a filter parameter and determine whether the alert condition should be generated based on the comparison.

The electronic surveillance system may generate an alert container that includes the alert condition and transmit the alert container to a surveillance interface. The surveillance interface may execute on a user device. A user may then interact with the alert container to facilitate resolution of the alert condition.

### BRIEF DESCRIPTION OF THE DRAWINGS

Features of the present disclosure may be illustrated by way of example and not limited in the following Figure(s), in which like numerals indicate like elements, in which:

FIG. 1 illustrates an example of an electronic surveillance system for detecting alert conditions in data networks;

FIG. 2 illustrates multi-branched filter parameter learning in the electronic surveillance system;

FIG. 3 illustrates a multi-tiered approach to learning filter parameters and detecting alert conditions in data networks;

FIG. 4 illustrates an example of multi-tiered processing to generate multiple signals for learning filter parameters and detecting alert conditions in data networks;

FIG. 5 illustrates a flow diagram of an example of an alert lifecycle;

FIG. 6 illustrates an example of a method of detecting alert conditions in data networks; and

FIG. 7 illustrates an example of a computer system that implements the electronic surveillance system illustrated in FIG. 1.

### DETAILED DESCRIPTION

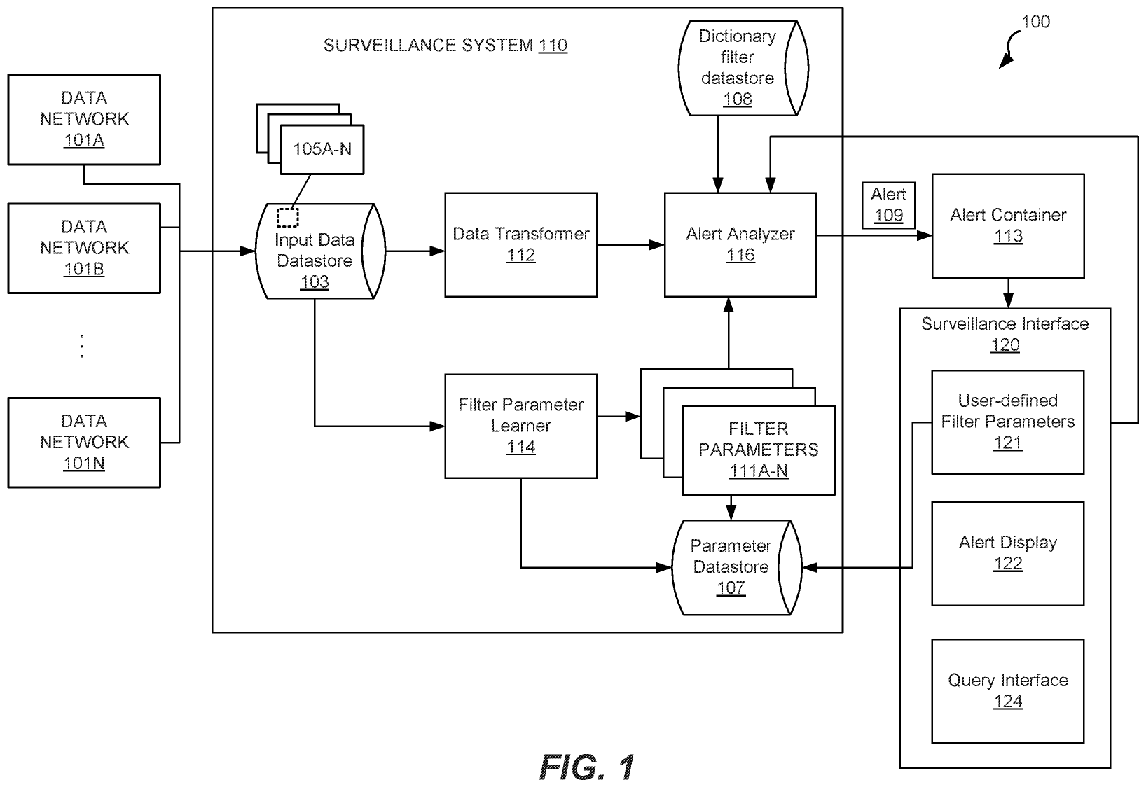

FIG. 1 illustrates an example of an electronic surveillance system 110 that detects, in a computer environment 100, alert conditions in data networks 101. An alert condition may refer to observed data in a data network that is outside the norm or expected. An alert condition may or may not require mitigation. This is because an alert condition may result from malicious activity on a data network or non-malicious activity that happens to deviate from the norm.

The computer environment 100 may include a plurality of data networks 101 (illustrated as data networks 101A . . . N), a surveillance system 110, a surveillance interface 120, and/or other features. A data network 101 may refer to a computer system that transmits and/or receives data, typically across a communication network (not shown), to or from their participants (also not shown).

The electronic surveillance system 110 may include an input data datastore 103, a parameter datastore 107, a dictionary filter datastore 108, a data transformer 112, a filter parameter learner 114, an alert analyzer 116, and/or other features. The electronic surveillance system 110 may receive input data from the data networks 101. The electronic surveillance system 110 may analyze the input data received from the data networks 101 to determine whether an alert condition should be triggered for that input data. The electronic surveillance system 110 may also store the input data as a data record 105 (collectively illustrated as data records 105A-N) in the input data datastore 103. As such, the electronic surveillance system 110 use the data records 105A-N as historical data for learning and improving detection of alert conditions. Each data record 105 may therefore include transactional data from a data network 101, messaging data (including text included in a message associated with a transaction) from a data network 101, and/or other types of data provided by a data network 101.

The electronic surveillance system 110 may include various features that facilitate alerts such as hardware and/or software instructions. For example, the electronic surveillance system 110 may include a processor, which may be a semiconductor-based microprocessor, a central processing unit (CPU), an application specific integrated circuit (ASIC), a field-programmable gate array (FPGA), and/or other suitable hardware device. It should be understood that the electronic surveillance system 110 may include multiple processors, multiple cores, or the like. The electronic surveillance system 110 may further include a memory, which may be an electronic, magnetic, optical, or other physical storage device that includes or stores executable instructions. The memory may be, for example, Random Access memory (RAM), an Electrically Erasable Programmable Read-Only Memory (EEPROM), a storage device, an optical disc, and the like. The memory may be a non-transitory machine-readable storage medium, where the term “non-transitory” does not encompass transitory propagating signals.

The data transformer 112, the filter parameter learner 114, and the alert analyzer 116 may each be implemented as instructions that program a processor of the electronic surveillance system 110. Alternatively, or additionally, the data transformer 112, the filter parameter learner 114, and the alert analyzer 116 may each be implemented in hardware.

The data transformer 112 may transform the input data from the input data datastore 103 into a format that is suitable for the filter parameter learner 114 and/or the alert analyzer 116. For example, the data transformer 112 may transform the data from a format used by the data networks 101 and/or the input data datastore 103 into a format that is suitable for the filter parameter learner 114 and/or the alert analyzer 116.

The filter parameter learner 114 may analyze historical datasets from the data networks 101 to learn one or more filter parameters 111 (illustrated as learned filter parameters 111A-N). A filter parameter 111 may refer to a value or range of values against which input data is compared to determine whether an alert condition for the input data is to be triggered.

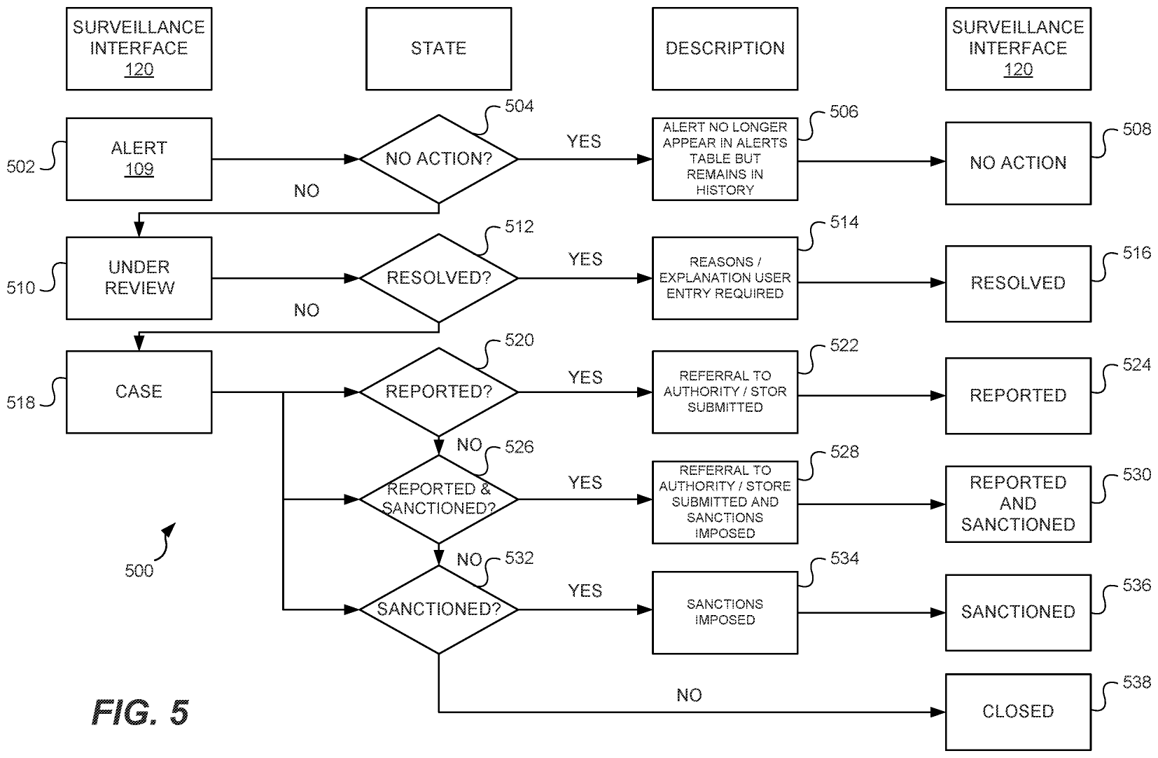

The filter parameter learner 114 may learn filter parameters 111 based on observations of percentage deviations, notional amounts, computational modeling including statistical analyses and machine-learning, and/or other techniques. Percentage deviation techniques involve learning a percentage deviation from the observed norm such as average in the historical datasets. The notional amount deviation may relate to a deviation based on notional amounts associated with a trade. A notional amount is the face value on which the calculations of payments on a financial instrument (such as a swap) are made. Computational modeling may include determining a number of standard deviations and observed mean that act as a filter parameter 111. In some examples, computational modeling may include machine-learning techniques. For example, in supervised machine-learning, labeled data in the historical datasets may be used to correlate filter parameters 111 with the labeled data. The labeled data may include the outcomes described later with respect to FIG. 5. In these supervised machine-learning examples, the filter parameters 111 may be based on weights learned from correlating the filter parameters 111 with the labeled data. In unsupervised machine-learning examples, values associated with the filter parameters 111 may be clustered together to determine correlations amongst these values. Such clustering may be used for analysis to determine that input data to be assessed is similar to clustered values in the historical datasets and that the outcome for the input data will likely be the same as outcome associated with the clustered values. For example, if the clustered values are associated with an alert condition, then the input data that matches with the clustered values are likely to be associated with the alert condition. In reinforcement learning examples, the filter parameter learner 114 may receive outcomes of predictions made by the alert analyzer 116, and use those as labeled data for further training. The filter parameter learner 114 may adjust weights associated with the learned filter parameters 111 based on the received outcomes. For example, if an alert condition was raised by the alert analyzer 116 and that alert condition was later confirmed, such confirmation feedback may be fed to the filter parameter learner 114, which may adjust the weights of the filter parameters 111 upward. On the other hand, if an alert condition was raised by the alert analyzer 116 and that alert condition was later determined to be resolved without concern, such confirmation feedback may be fed to the filter parameter learner 114, which may adjust the weights of the filter parameters 111 downward.

In some examples, the dictionary filter datastore 108 may be learned based on supervised or unsupervised machine-learning. The dictionary filter datastore 108 may include text that is flagged for raising an alert condition. The text may be predefined by users and/or may be learned by the filter parameter learner 114. For example, in supervised machine-learning, the filter parameter learner 114 may correlate text in the data record 105 with labeled outcomes, such as those discussed with respect to FIG. 5. In this way, the filter parameter learner 114 may learn text (such as a word or combinations of words) that correlate with different types of outcomes. In particular, certain text may be correlated with alerts that were reported and sanctioned, which may refine future alert generation since future data records 105 that include the certain text may be flagged for alerts.

Regardless of the particular manner in which the filter parameter learner 114 learns the filter parameters 111, in various examples, the filter parameter learner 114 may conduct multi-branched parameter learning and/or multi-tiered parameter learning in a multi-signal environment.

Multi-Branched Parameter Learning

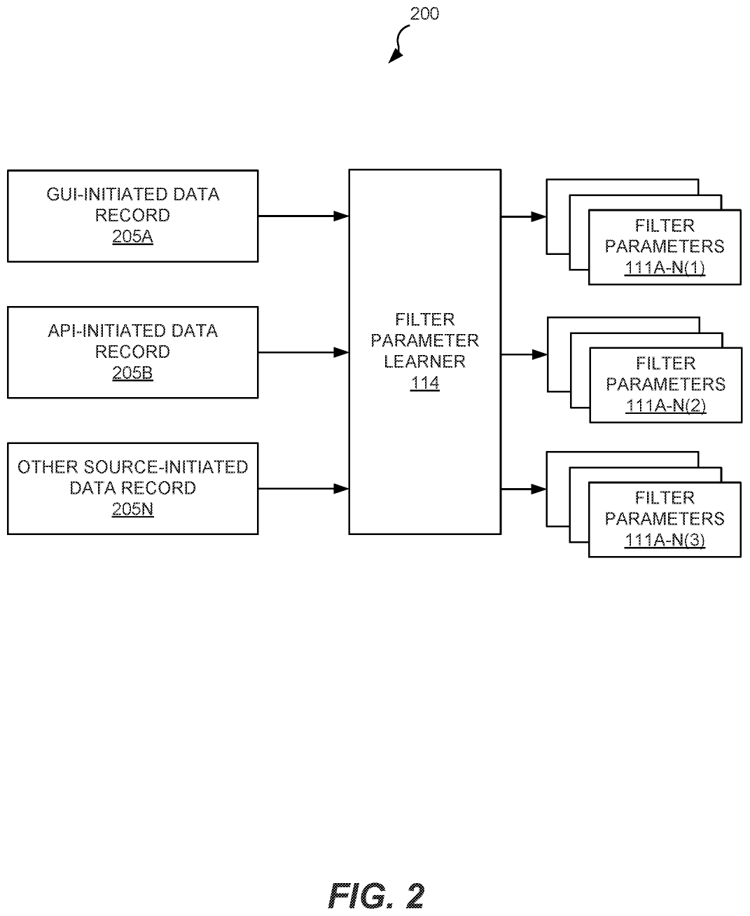

In some examples, the filter parameter learner 114 may be branched to learn different filter parameters 111 in different contexts. For example, FIG. 2 illustrates multi-branched filter parameter learning in the electronic surveillance system 110. Referring to FIG. 2, the electronic surveillance system 110 may branch parameter learning depending on a source associated with a data record 105 that is being processed for learning. For example, input data from a given data network 101 may be the result of a transaction initiated from a graphical user interface (“GUI”). This input data is illustrated as GUI-initiated data record 205A. For example, a trade may be made directly by a user via a GUI, resulting in a trade match that is recorded as a GUI-initiated data record 205A. As such, the data record 205A may be associated with a source that is a GUI. In another example, data record 205B may be the result of a transaction initiated from an application programming interface (“API”). This input data is illustrated as API-initiated data record 205B. As such, the data record 205B may be associated with another source that is an API. Other input data may be the result of transactions initiated by other types of sources. This input data is illustrated as other source-initiated data record 205N. The filter parameter learner 114 may implement multi-branched learning because alert conditions may vary across the different branches.

For example, GUI-initiated data records 205A may result from trades that are typically not driven by high frequency trading (“HFT”) or algorithmic trading. On the other hand, API-initiated data records 205B may result from trades that are driven by HFT or algorithmic trading and therefore will generally have lower transaction volumes, timing, and/or other factors. Thus, alert conditions may vary depending on the type of data records 205 being analyzed. As such, for each branch, the filter parameter learner 114 may generate filter parameters for its corresponding branch. As illustrated, for example, the filter parameter learner 114 may learn filter parameters 111A-N(1) for GUI-initiated data records 205A, filter parameters 111A-N(2) for API-initiated data records 205B, and filter parameters 111A-N(3) for other source-initiated data records 205N. It should be noted that the data records 205A-N may each be stored as a data record 105 in the input data datastore 103 with an indicator that indicates its source-initiation, such as an indication that a corresponding trade was initiated from a GUI, API, or other source.

Multi-Tiered Parameter Learning

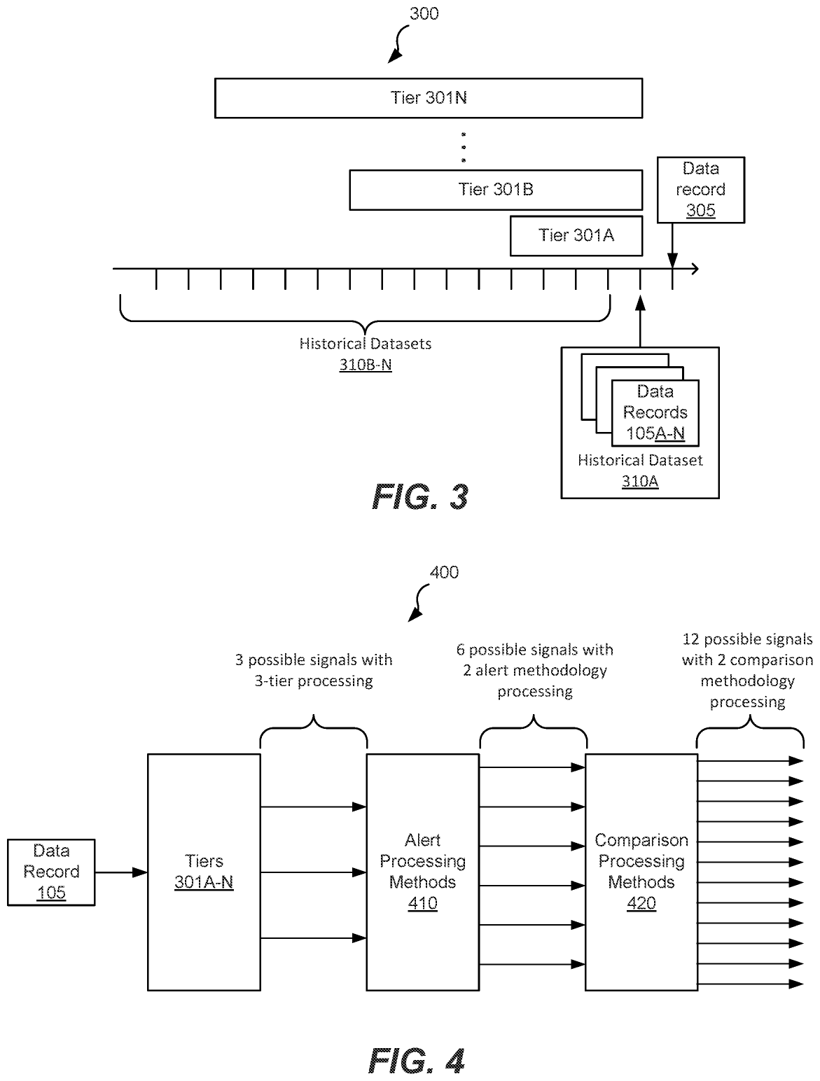

In some examples, the filter parameter learner 114 may learn filter parameters 111 across multiple tiers. For example, FIG. 3 illustrates a multi-tiered approach to learning filter parameters 111 and detecting alert conditions in data networks 101. As illustrated, multiple tiers 301 (illustrated as tiers 301A-N) may be used to learn filter parameters 111 and detect alert conditions. Each tier 301 may represent a sample size of historical datasets 310 on which to learn filter parameters 111, which are used to assess a data record 305 to determine whether an alert condition is to be generated for the data record 305. For example, a tier 301 may represent a period of time (such as number of days of historical datasets 310) from which to learn filter parameters 111 and/or apply the filter parameters 111 during the detecting phase.

Each tick mark in the horizontal line represents a single historical dataset 310 (collectively illustrated as historical datasets 310A-N). For convenience, only historical dataset 310A is shown in detail to illustrate that each historical dataset 310 includes a plurality of data records 105A-N for a given day. It should be noted that time points other than days may be used, such as hourly, weekly, monthly, and so forth. Thus, hourly, weekly, or monthly data records may be used. It should be further noted that although the analyzed historical datasets 310 are immediately adjacent to the data record 305, there may be a gap of time between the data record 305 and the historical datasets 310. Such gap may be configurable by the user and/or may be predefined. As illustrated, the gap is zero. In other words, as illustrated, if the data record 305 corresponds to today's data, the analyzed historical datasets 310 are includes a number of days before today through yesterday. The number of days before today through yesterday may define each tier 301.

Longer tiers 301 may define longer periods over which to learn filter parameters 111. For example, tier 301N may encompass more historical datasets 310 than tier 301B. Tier 301B may encompass more historical datasets 310 than tier 301A. For example, tier 301A may include one week of historical datasets 310, tier 301B may include one month of historical datasets 310, and tier 301N may include three months of historical datasets 310 (FIG. 3 is not drawn to scale to show this example; FIG. 3 is drawn to merely show different lengths of tiers 301). In some examples, a given tier 301 may be system-defined and immutable by the user. In some examples, the user may configure the length of a given tier 301, which may be used by the filter parameter learner 114. In some examples, the user may select which ones of the tiers 301A-N are to be used for learning and/or detecting.

In some examples, different tiers 301 may be used for different types of data records. For example, tier 301A may be used to learn filter parameters 111A-N(2) for API-initiated data records 205B while tier 301N may be used to learn filter parameters 111A-N(1) for GUI-initiated data records 205A. Other combinations of tiers 301A-N and data records 205A-N may be used to learn filter parameters 111 and/or apply the filter parameters 111.

In some examples, a tier 301 may be configured to cover a specific length of time regardless of a length of time that is relevant for a data record 305 being assessed. For example, if the data record 305 relates to a 37 day forward in which a foreign exchange contract is set for 37 days, a tier 301 may be set to cover two months between pillar nodes (that define the length of the contract). In this way, a consistent dataset may be selected from which to learn relevant filter parameters 111.

Multi-Signal Alert Conditions

In some examples, the electronic surveillance system 110 may process multiple signals during learning and detection phases. For example, FIG. 4 illustrates an example of generating multiple signals for learning filter parameters 111 and detecting alert conditions in data networks 101. A “signal” as used herein refers to a collection of information that may be used to determine whether an alert condition should be generated. The collection of information in a signal may include a genre of alert condition (where a first signal may relate to a first genre and a second signal may relate to a second genre), one or more fields in a data record 105, one or more tiers 301 used for analysis, filter values other than filter parameters 111, and/or other information described herein to determine whether an alert condition should be generated. Thus, the number and type of signals may vary based on different combinations of data analyzed as described herein.

Referring now to FIG. 4, a data record 105 may be analyzed (for learning and/or detecting phases) in the context of different tiers 301A-N. For example, if three tiers 301 are used, then three signals will result for that data record 105 (one signal per tier 301). In one example, trade sizes may be processed for one week (trade size for tier 301A), one month (trade size for tier 301B), and three months (trade size for tier 301N). Each of these three signals may be processing by various alert processing methods 410, such as a percent average signal to obtain an average trade size and percent large signal to obtain what constitutes a large trade size. For example, an average trade size may be determined for: one week of historical datasets 310 (tier 301A), one month of historical datasets 310 (tier 301B), and three months of historical datasets 310 (tier 301N). Likewise, what constitutes a large trade size may be determined for: one week of historical datasets 310 (tier 301A), one month of historical datasets 310 (tier 301B), and three months of historical datasets 310 (tier 301N). In this manner, a total of six signals may result.

These six signals may undergo comparison processing methods 420. If two comparison processing methods 420 are used (such as to compare a data record 305 of the trader to historical datasets of that same trader or to compare the data record 305 of the trader to those of other traders). In this example, a total of twelve signals will be generated. It should be noted that these twelve signals may be used to determine whether an alert condition should be generated for the trader that submitted the trade recorded in the data record 305 but also may be used to determine whether an alert condition should be generated for the counterparty of the trade recorded in the data record 305. Thus, a total of 24 signals may be generated for the trader and the counterparty.

In some examples, each of the signals may be individually used to generate alert conditions for a given trader and/or a counterparty to a trade recorded in the data record 305. For example, a first alert condition may be generated if a trade conducted by the trader is a certain percentage larger than the trader's one week average number of trades for a given instrument. A second alert condition may be generated if the trade conducted by the trader is a certain percentage larger than the trader's one month average number of trades for the given instrument. It should be further noted that a third alert condition for another signal may not be generated such as when the trade conducted by the trader is not a certain percentage larger than the trader's three month average number of trades for the given instrument. It should be further noted that a comparison may be made to other traders, but only within that trader's own organization, and not all other traders for all organizations. It should be noted that a given user may configure the number and type of signals used for alert generation. For example, a first user may select a first set of signals (such as signals 5 through 22) to use for alert generation while a second user may select a second set of signals to use for alert generation (such as signals 1-6 and 24).

Generating Alerts

The alert analyzer 116 may analyze the input data from the data transformer 112 and compare one or more values in the input data with the corresponding threshold values of the learned filter parameters 111A-N. In some examples, the alert analyzer 116 may replace a filter parameter 111 with a corresponding user-defined filter parameter 121. In these examples, the learned filter parameters 111A-N may serve as default parameters for alert flagging and the alert analyzer 116 may replace one or more of the learned filter parameters 111A-N with a corresponding user-defined filter parameter 121. It should be noted that the learned filter parameters 111 and/or the user-defined filter parameters 121 may be stored for later retrieval in the parameter datastore 107. For example, each of the user-defined filter parameters 121 may be stored in association with a user identifier of a user that defined them. The learned filter parameters 111 may be stored in association with conditions under which they were learned, such as the tier, branch, and/or other condition.

The alert analyzer 116 may analyze each signal to determine whether to generate an alert condition for that signal. For example, the alert analyzer may compare one or more fields in the input data (which may be the data record 105 transformed by the data transformer 112 for analysis and/or the data record 105 directly from the input data datastore 103) with corresponding one or more fields in the historical datasets 310 in a given tier 301. In particular, the alert analyzer 116 may determine a difference between the one or more fields in the input data with the one or more fields in the historical datasets 310 and compare the difference to a corresponding learned filter parameter 111. In a particular example, the alert analyzer 116 may determine a difference between a trade size in the input data with an average trade size in a one-month period (such as a tier 301B) in the historical datasets 310, compare the difference to a learned input parameter 111 that defines a difference threshold, and generate an alert condition if the difference deviates from the difference threshold.

In some examples, the alert analyzer 116 may use various algorithmic techniques that may be applied across different types of datasets. To illustrate, operation of the alert analyzer 116 will be described in the context of generating alert conditions in data records 105 that represent trading data. For example, the alert analyzer 116 may generate alerts across multiple products and liquidity pool models in a way that facilitates user-defined configurations of what to look for in the trading data. In this context, the user-defined configurations may be stored as user-defined filter parameters 121 that the alert analyzer 116 uses to analyze the data records 105.

For example, the alert analyzer 116 may use a localization algorithm in price space for barrier manipulation that allows the system to detect unknown forces within the underlying instrument to detect possible manipulation of exotic option exit risk for both European and American style derivatives based on price and timing of those derivatives. In this example, the alert analyzer 116 may accept a user-defined filter parameter 121 that specifies value in price space (P*) in equation (1) and frequency when P* is exceeded.

Pᵢ−Pᵢ₊₁<P* (1),

in which:

Pᵢ is a price at time (i),

Pᵢ₊₁ is a price at the next time increment (i+1), and

P* is a user-specified value in price space.

The alert analyzer 116 may iterate each time increment to evaluate equation (1) to determine the result is true or not, and then count the number of true evaluations. For example, the alert analyzer 116 may iterate multiple data records 105 over time to evaluate P₁−P₂, P₂−P₃, P₃−P₄, and so on. Over time, the alert analyzer 116 may count the number of times that equation (1) evaluates to true over these localized instances of price value, and compare the number of times to a frequency value specified by the user. Thus, the user may specify the value of P* and frequency filter that an alert condition is to be thrown, and the alert analyzer 116 may analyze data records 105 to discover alert conditions in a highly localized manner that may not rely on prior graph-pattern analyses or full client option book with known triggers or barrier levels.

In another example, the alert analyzer 116 may use a cancel amend algorithm that was designed to reflect that the action of placing and canceling an order in a way that is worthy of investigation implies that time is not distributed in a linear fashion. In other words, the alert analyzer 116 may recognize that entry time and cancel time across all the temporal pillars are all important but different.

In another example, the alert analyzer 116 may use an unusual bid offer algorithm comprising a single core algorithm that can analyze both Central Limit Order Books (“CLOBs”) as well as private negotiated contracts such as a Request for Quote and across multiple Products. This is due to the recognition that architecting by use case is a core weakness of development rather doing to the full analysis for a general principle that will be parsimonious, inform the system about the past, and make predictions about the future.

In another example, the alert analyzer 116 may use spoofing logic that recognizes the importance of order position in price space, ratio driven analysis between bona fide and suspicious orders as well as all the temporal stress tests that the algorithm must analyze to develop a single signal which is key in balancing false positives with false negatives.

In some examples, the alert analyzer 116 may use a large order algorithm that exposes how actionable orders are both managed and placed which leverages the large trade methodology and places it at the order level exposing multiple scenarios when deployed into production.

In the foregoing examples, agnostic analytics and patterns are the core theme that links all the algorithms. there may be no attempt to curve fit data to a goal output, but rather the alert analyzer 116 may discover relationships.

The alert analyzer 116 may generate an alert container 113 that includes a result of alert condition analysis, which is based on an evaluation of the learned filter parameters 111 and/or user-defined filter parameters 121. The surveillance interface 120 may include a GUI input to receive user-defined filter parameters 121, an alert display 122 that generates an interface for presenting information in the alert container 113, a query interface 124 that facilitates querying data relating to alerts, and/or other components. The alert display 122 may parse the alert container 113 and display the alert conditions.

User-Defined Customizations

In some examples, a given user that provided the user-defined alert parameter 121 may be part of a group. In this example, the electronic surveillance system 110 may store an association of a group identifier that identifies the group with user identifiers that each identify a user that is part of the group. The alert analyzer 116 may use the user-defined filter parameter 121 defined by the user for each member of the group. In other words, the electronic surveillance system 110 may enforce the user-defined filter parameter 121 across the entire group. This may facilitate difference groups within an organization, such as legal or compliance groups, to define group-specific monitoring and surveillance.

In some examples, a user may specify the number and/or type of signals to be analyzed. In particular, a user may select and identify ten signals to use while another may select and identify 20 signals to use. In this manner, different users may specify which signals are important to them. Like user-defined filter parameters 121, in some examples, user-defined selection of signals may be enforced across a user's group, making the user-defined selection of signals group-specific.

The electronic surveillance system 110 may operate in training and detecting phases relating to intrusion detection (such as abnormal attempted logons) for network security. For illustrative purposes, another example operation will be described in the context of analyzing input data received from Electronic Trading Venues and related platforms provided by these venues (referred to as “ETVs”). These examples will be described for illustrative purposes. ETVs are examples of data networks 101 that receive electronic trade orders from buyside and sell-side participants, match the orders, and facilitate order completion between the participants. ETVs may generally have a responsibility to flag suspicious activity on their networks to, among other things, maintain fairness, mitigate against manipulation, and/or detect laundering activity. Examples of ETVs include, among others, electronic foreign (currency) exchanges, platforms such as messaging and data platforms that facilitate trades. Electronic foreign exchanges and other trading venues may provide the electronic surveillance system with data that indicate buyside and sell-side trade matches. In some examples, the electronic foreign exchanges and other trading venues may provide the electronic surveillance system 110 with data that indicates unmatched buyside or sell-side orders. The electronic surveillance system 110 may determine whether to generate alert conditions for the matched or unmatched orders based on learned and/or user-defined filter parameters as described herein.

In some examples, messaging platforms that facilitate trades may include messages such as chats. The electronic surveillance system 110 may determine whether the messages include text in the dictionary filter datastore 108, and generate alert conditions for the messages based on the determination. In some examples, the messages may refer to an order identifier. In these examples, the electronic surveillance system 110 may associate the messages with orders from the venues based on the order identifier. Further in these examples, the electronic surveillance system 110 may generate alert conditions for a given order in the input data from an ETV so that alert conditions for the order and any corresponding message may be combined and considered together.

The electronic surveillance system 110 may determine whether trades conducted via ETVs raise specific alert conditions relevant to suspicious activity on the ETVs. For example, during the learning phase, the filter parameter learner 114 may learn filter parameters 111 such as a large trade size, an average large trade size, and/or other types of values that may be learned from historical datasets in this or other contexts.

For example, genres of alert conditions in the context of ETVs may include a large trade alert, a layering alert, and a tagging alert. A large trade is an executed order (matched) that is above a determined threshold quantity. Layering is a form of spoofing, where a trader enters one or more same side orders (deceptive, spoof) in order to improve the price and/or quantity of the to of book positioning. Tagging (also known as Momentum Ignition) is the action of placing a series of same side Orders at the top of book with the minimum price increment and thereafter canceling that/those series of orders within a short time period, so that there is no executed order on that side of the market. The intention is for the repeated behavior to help move the market in the direction in which the order is placed, exacerbate any movement in the direction the order was placed and generally mislead the other participants as to the true intentions of the abusive activity.

FIG. 5 illustrates a flow diagram 500 of an example of an alert lifecycle. At 502, an alert 109 may be generated and provided through the surveillance interface 120. At 504, a determination of whether action should be taken may be made. If no action is to be taken, such as based on a determination by a receiving analyst user, at 506, the alert may no longer appear in an alerts table of the surveillance interface 120, but may be retained in a history of alerts. At 508, no further action may be taken on the alert 109.

Returning to 504, if action is to be taken, at 510, the alert 109 may be under further review. At 512, if a resolution on the alert is made, then at 514, a reason or explanation why the alert has been resolved may be required. At 516, the analyst user may input the reasons and the alert 109 may be placed in a resolved status.

Returning to 512, if the alert 109 is not resolved after further review by the analyst user, then at 518, a case may be generated for the alert. When a case is made, various outcomes may result: the case may be reported to appropriate authorities at 520-524, the case may be reported to and sanctioned by the appropriate authorities at 526-530, the case may be sanctioned at 532-536, or the case may be closed at 538 without reporting or sanctions. It should be noted that any of the results of the alert 109 at 508, 516, 524, 530, 536, or 538 may serve as training data to learn from the alert 109. For example, each of these result conditions may serve as a labelled outcome for machine learning. In this example, which various signals (examples of which are described at FIG. 4) may be correlated with the labelled outcome.

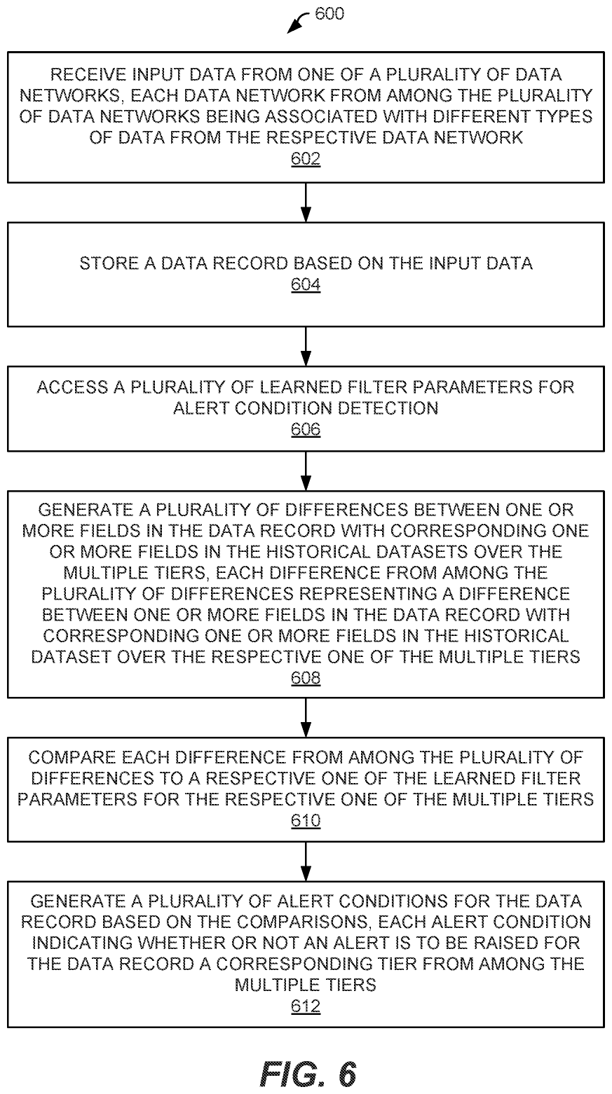

FIG. 6 illustrates an example of a method 600 of detecting alert conditions in data networks 101A-N. At 602, the method 600 may include receiving input data from one of a plurality of data networks 101A-N. Each data network 101 from among the plurality of data networks 101A-N may be associated with different types of data from the respective data network 101. For example, first input data received from a data network 101A may relate to a foreign exchange transaction from a first electronic venue while second input data received from a data network 101B may relate to another type of foreign exchange transaction from a second electronic venue.

At 604, the method 600 may include storing a data record 105 based on the input data. For example, the method 600 may include storing the data record 105 in the input data datastore 103.

At 606, the method 600 may include accessing a plurality of learned filter parameters 111 for alert condition detection. Each learned filter parameter 111 from among the plurality of learned filter parameters 111 may be learned from historical datasets 310 over a respective one of multiple tiers 301A-N using computational modeling based on statistical analysis and/or machine-learning. Each learned filter parameter 111 may define a value or range of values for which an alert condition is to be raised with respect to the respective one of the multiple tiers 301A-N. For example, a first learned filter parameter 111 may relate to a first tier 301A and a second learned filter parameter 111 may relate to a second tier 301B.

At 608, the method 600 may include generating a plurality of differences between one or more fields in the data record 105 with corresponding one or more fields in the historical datasets 310 over the multiple tiers, each difference from among the plurality of differences representing a difference between one or more fields in the data record 105 with corresponding one or more fields in the historical datasets 310 over the respective one of the multiple tiers 301. For example, a field may include a trade size and the difference may relate to a difference between an average trade size in the historical datasets and a current trade size of a trade recorded in the data record 105.

At 610, the method 600 may include comparing each difference from among the plurality of differences to a respective one of the learned filter parameters 111 for the respective one of the multiple tiers 301. For example, a first learned filter parameter 111 may relate to a range of average trade sizes in one week of data for tier 301A outside of which is to be considered abnormal and trigger a first alert condition. A second learned filter parameter 111 may relate to a range of average trade sizes in one month of data for tier 301B outside of which is to be considered abnormal and trigger a second alert condition. The difference in the current trade size and the average trade size in one week of data for tier 301A may be compared to these learned ranges.

At 612, the method 600 may include generating a plurality of alert conditions for the data record based on the comparisons. Each alert condition may indicate whether or not an alert is to be raised for the data record a corresponding tier from among the multiple tiers 301. For example, the first alert condition may (or may not) be generated for tier 301A and the second alert condition may (or may not) be generated for tier 301B. It should be noted that any number of alert conditions may be raised for each of the tiers 301 and/or other signals.

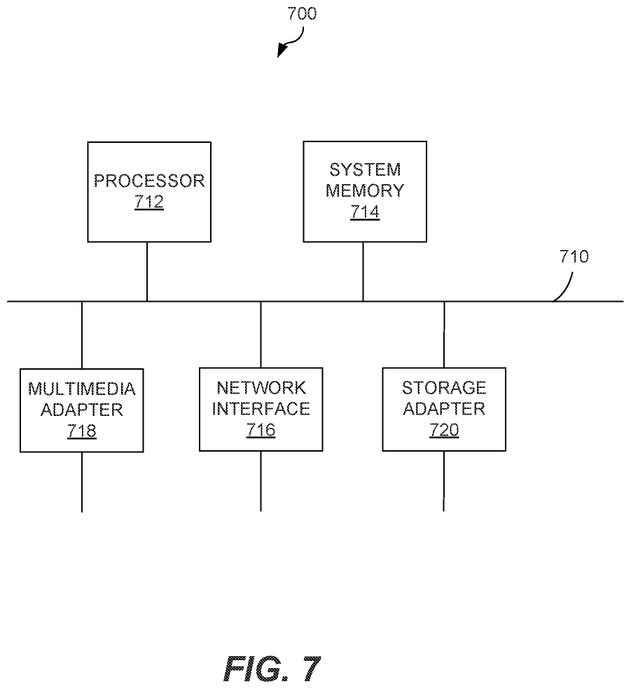

FIG. 7 illustrates an example of a computer system that implements the electronic surveillance system 110 illustrated in FIG. 1. The computer system 700 may include, among other things, an interconnect 710, a processor 712, a multimedia adapter 714, a network interface 716, a system memory 718, and a storage adapter 720.

The interconnect 710 may interconnect various subsystems, elements, and/or components of the computer system 700. As shown, the interconnect 710 may be an abstraction that may represent any one or more separate physical buses, point-to-point connections, or both, connected by appropriate bridges, adapters, or controllers. In some examples, the interconnect 710 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1364 bus, or “firewire,” or other similar interconnection element.

In some examples, the interconnect 710 may allow data communication between the processor 712 and system memory 718, which may include read-only memory (ROM) or flash memory (neither shown), random-access memory (RAM), and/or other non-transitory computer readable media (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 712 may control operations of the computer system 700. In some examples, the processor 712 may do so by executing instructions such as software or firmware stored in system memory 718 or other data via the storage adapter 720. In some examples, the processor 712 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 714 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 716 may provide the computer system 700 with an ability to communicate with a variety of remote devices over a network. The network interface 716 may include, for example, an Ethernet adapter, a Fibre Channel adapter, and/or other wired- or wireless-enabled adapter. The network interface 716 may provide a direct or indirect connection from one network element to another, and facilitate communication and between various network elements.

The storage adapter 720 may connect to a standard computer readable medium for storage and/or retrieval of information, such as a fixed disk drive (internal or external).

Other devices, components, elements, or subsystems (not illustrated) may be connected in a similar manner to the interconnect 710 or via a network. The network may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network.

The devices and subsystems can be interconnected in different ways from that shown in FIG. 7. Instructions to implement various examples and implementations described herein may be stored in computer-readable storage media such as one or more of system memory 718 or other storage. Instructions to implement the present disclosure may also be received via one or more interfaces and stored in memory. The operating system provided on computer system 700 may be MS-DOS®, MS-WINDOWS®, OS/2®, OS X®, IOS®, ANDROID®, UNIX®, Linux®, or another operating system.

The databases (such as the input data datastore 103, the parameter datastore 107, and the dictionary filter datastore 108) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

In FIG. 1, as well as in other drawing Figures, different numbers of entities than those depicted may be used. Furthermore, according to various implementations, the components described herein may be implemented in hardware and/or software that configure hardware.

For simplicity and illustrative purposes, the disclosure included descriptions that may refer to examples. In the description, numerous specific details have been set forth in object to provide a thorough understanding of the present disclosure. It will be readily apparent however, that the disclosure may be practiced without limitation to these specific details. In other instances, some methods and structures have not been described in detail so as not to unnecessarily obscure the present disclosure. In some instances, various method operations may be omitted and the various method operations are not necessarily performed in the object in which they are presented. It should be understood that the various method operations may be performed by some or all of the features described with reference to FIG. 1.

Throughout the disclosure, the term “a” and “an” may be intended to denote at least one of a particular element. As used herein, the term “includes” means includes but not limited to, the term “including” means including but not limited to. The term “based on” means based at least in part on.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure. What has been described and illustrated herein is an example of the disclosure along with some of its variations. The terms, descriptions and figures used herein are set forth by way of illustration only and are not meant as limitations. As such, the disclosure is intended to be defined by the following claims—and their equivalents—in which all terms are meant in their broadest reasonable sense unless otherwise indicated.

What is claimed is:

1. An electronic surveillance system that detects alert conditions in data networks, the electronic surveillance system comprising a processor programmed to:
receive input data from one of a plurality of data networks, each data network from among the plurality of data networks being associated with different types of data from the respective data network;
store a data record based on the input data;
access a plurality of learned filter parameters for alert condition detection, each learned filter parameter from among the plurality of learned filter parameters being learned from historical datasets over a respective one of multiple tiers using computational modeling based on statistical analysis and/or machine-learning and defining a value or range of values for which an alert condition is to be raised with respect to the respective one of the multiple tiers;
generate a plurality of differences between one or more fields in the data record with corresponding one or more fields in the historical datasets over the multiple tiers, each difference from among the plurality of differences representing a difference between one or more fields in the data record with corresponding one or more fields in the historical datasets over the respective one of the multiple tiers;
compare each difference from among the plurality of differences to a respective one of the learned filter parameters for the respective one of the multiple tiers; and
generate a plurality of alert conditions for the data record based on the comparisons, each alert condition indicating whether or not an alert is to be raised for the data record a corresponding tier from among the multiple tiers.

2. The electronic surveillance system of claim 1, wherein the processor is further programmed to:
receive, from a user, a user-defined filter parameter; and
replace at least one of the plurality of learned filter parameters with the user-defined filter parameter, wherein the plurality of alert conditions is generated based on the user-defined filter parameter instead of the replaced one of the plurality of learned filter parameters.

3. The electronic surveillance system of claim 2, wherein the user is part of a group of users, and wherein processor is further programmed to:
use the user-defined filter parameter for all users in the group.

4. The electronic surveillance system of claim 1, wherein to generate the plurality of differences between one or more fields in the data record with corresponding one or more fields in the historical dataset, the processor is further programmed to:
limit the historical datasets to those associated with a user that is the same user that is also associated with the data record to make the comparison to historical activity of the user.

5. The electronic surveillance system of claim 1, wherein to generate the plurality of differences between one or more fields in the data record with corresponding one or more fields in the historical dataset, the processor is further programmed to:
limit the historical datasets to those associated with users in the same organization as the user associated with the data record to make the comparison to historical activity of an organization of a user.

6. The electronic surveillance system of claim 1, wherein to generate the plurality of differences between one or more fields in the data record with corresponding one or more fields in the historical dataset, the processor is further programmed to:
limit the historical datasets to those associated with an instrument that is the same instrument in the data record to make the comparison specific to the instrument across all users.

7. The electronic surveillance system of claim 1, wherein the processor is further programmed to:
receive, from a user, a number and type of a plurality of signals to use for alert generation, wherein a number of the plurality of signals is based on the multiple tiers and the one or more fields and wherein each signal of the plurality of signals is assessed to generate a corresponding alert condition.

8. The electronic surveillance system of claim 7, wherein the user is part of a group of users, and wherein processor is further programmed to:
use the number and the type of the plurality of signals for all users in the group.

9. The electronic surveillance system of claim 1, wherein to generate the plurality of differences, the processor is further programmed to:
determine a percentage deviation between the one or more fields in the data record with corresponding one or more fields in the historical dataset.

10. The electronic surveillance system of claim 1, wherein to generate the plurality of differences, the processor is further programmed to:
determine a notional quantity deviation between the one or more fields in the data record with corresponding one or more fields in the historical dataset.

11. The electronic surveillance system of claim 1, wherein to generate the plurality of differences, the processor is further programmed to:
determine a statistical deviation between the one or more fields in the data record with corresponding one or more fields in the historical dataset.

12. The electronic surveillance system of claim 1, wherein the processor is further programmed to:
conduct multi-branched filter parameter learning to learn the plurality of learned filter parameters and a second set of a plurality of learned filter parameters for second historical datasets, the multi-branched filter parameter learning being based on a first source associated with the historical datasets and a second source associated with the second historical datasets;
identify a source associated with the data record; and
select the plurality of learned filter parameters based on a match between the source associated with the data record and the first source associated with the historical datasets.

13. A method of detecting alert conditions in data networks, the method comprising:
receiving, by an electronic surveillance system, input data from one of a plurality of data networks, each data network from among the plurality of data networks being associated with different types of data from the respective data network;
storing, by the electronic surveillance system, a data record based on the input data;
accessing, by the electronic surveillance system, a plurality of learned filter parameters for alert condition detection, each learned filter parameter from among the plurality of learned filter parameters being learned from historical datasets over a respective one of multiple tiers using computational modeling based on statistical analysis and/or machine-learning and defining a value or range of values for which an alert condition is to be raised with respect to the respective one of the multiple tiers;
generating, by the electronic surveillance system, a plurality of differences between one or more fields in the data record with corresponding one or more fields in the historical datasets over the multiple tiers, each difference from among the plurality of differences representing a difference between one or more fields in the data record with corresponding one or more fields in the historical datasets over the respective one of the multiple tiers;
comparing, by the electronic surveillance system, each difference from among the plurality of differences to a respective one of the learned filter parameters for the respective one of the multiple tiers; and
generating, by the electronic surveillance system, a plurality of alert conditions for the data record based on the comparisons, each alert condition indicating whether or not an alert is to be raised for the data record a corresponding tier from among the multiple tiers.

14. The method of claim 13, further comprising:
receiving, from a user, a user-defined filter parameter; and
replacing at least one of the plurality of learned filter parameters with the user-defined filter parameter, wherein the plurality of alert conditions is generated based on the user-defined filter parameter instead of the replaced one of the plurality of learned filter parameters.

15. The method of claim 14, wherein the user is part of a group of users, and wherein processor is further programmed to:
using the user-defined filter parameter for all users in the group.

16. The method of claim 13, wherein generating the plurality of differences between one or more fields in the data record with corresponding one or more fields in the historical dataset, comprises:
limiting the historical datasets to those associated with a user that is the same user that is also associated with the data record to make the comparison to historical activity of the user.

17. The method of claim 13, wherein generating the plurality of differences between one or more fields in the data record with corresponding one or more fields in the historical dataset comprises:
limiting the historical datasets to those associated with users in the same organization as the user associated with the data record to make the comparison to historical activity of an organization of a user.

18. The method of claim 13, further comprising:
conducting multi-branched filter parameter learning to learn the plurality of learned filter parameters and a second set of a plurality of learned filter parameters for second historical datasets, the multi-branched filter parameter learning being based on a first source associated with the historical datasets and a second source associated with the second historical datasets;
identifying a source associated with the data record; and
selecting the plurality of learned filter parameters based on a match between the source associated with the data record and the first source associated with the historical datasets.

19. A computer readable storage medium storing instructions that, when executed by a processor, programs the processor to:
receive input data from one of a plurality of data networks, each data network from among the plurality of data networks being associated with different types of data from the respective data network;
store a data record based on the input data;
access a plurality of learned filter parameters for alert condition detection, each learned filter parameter from among the plurality of learned filter parameters being learned from historical datasets over a respective one of multiple tiers using computational modeling based on statistical analysis and/or machine-learning and defining a value or range of values for which an alert condition is to be raised with respect to the respective one of the multiple tiers;
generate a plurality of differences between one or more fields in the data record with corresponding one or more fields in the historical datasets over the multiple tiers, each difference from among the plurality of differences representing a difference between one or more fields in the data record with corresponding one or more fields in the historical datasets over the respective one of the multiple tiers;
compare each difference from among the plurality of differences to a respective one of the learned filter parameters for the respective one of the multiple tiers; and
generate a plurality of alert conditions for the data record based on the comparisons, each alert condition indicating whether or not an alert is to be raised for the data record a corresponding tier from among the multiple tiers.

20. The computer readable storage medium of claim 19, wherein the instructions, when executed, further program the processor to:
receive, from a user, a user-defined filter parameter; and
replace at least one of the plurality of learned filter parameters with the user-defined filter parameter, wherein the plurality of alert conditions is generated based on the user-defined filter parameter instead of the replaced one of the plurality of learned filter parameters.
